(19) United States
(12) Patent Application Publication
(10) Pub. No.: US 2025/0187347 A1
(43) Pub. Date: Jun. 12, 2025

(54) PRINTHEAD FOR A PRINTING APPARATUS

(71) Applicant: Hand Held Products, Inc., Charlotte, NC (US)

(72) Inventors: Shashikant G GULAGULI, Charlotte, NC (US); Samantula Bahskar RAO, Charlotte, NC (US); Karthik GUNDLAPALLI, Charlotte, NC (US); Santosh Kumar BALLOLLI, Charlotte, NC (US); Ravi Raju UNDAMATLA, Charlotte, NC (US); Sunil Kumar MISHRA, Charlotte, NC (US); Gudimella Venkata Sai BHARATH, Charlotte, NC (US); Harish AKUTHOTA, Charlotte, NC (US)

(21) Appl. No.: 18/957,006

(22) Filed: Nov. 22, 2024

(30) Foreign Application Priority Data
Dec. 7, 2023 (IN) 202311083418

(51) Int. Cl. B41J 2/355; B41J 2/335; B41J 2/345; B41J 3/407

(52) U.S. Cl. CPC B41J 2/355; B41J 2/33505; B41J 2/33575; B41J 2/3358; B41J 2/345; B41J 3/4075

(57) ABSTRACT

Provided herein is a printhead for a printing apparatus. The printhead comprises a first burn line of heating elements disposed on a first surface of the printhead, and a second burn line of heating elements disposed on a second surface of the printhead. The second surface is opposite to the first surface. Thereafter, one of the first burn line of heating elements or the second burn line of heating elements is configured to perform a printing operation.

### CROSS-REFERENCE TO RELATED APPLICATIONS

This application claims priority pursuant to 35 U.S.C. 119 (a) to Indian Application No. 202311083418, filed Dec. 7, 2023, which application is incorporated herein by reference in its entirety.

### FIELD OF THE DISCLOSURE

Example embodiments of the present disclosure relate generally to printers, and more particularly, to a printhead of a printing apparatus.

### BACKGROUND OF THE DISCLOSURE

Thermal printers are employed in a production facility such as warehouse, distribution centers, healthcare scenario etc., for printing thousands of labels each day. The thermal printers use heat energy to induce markings on a record media by selectively heating specific areas of the record media or by heating a thermal transfer media for various printing applications. Conventional thermal printers consist of a printhead that contain print dots. The printhead prints a label by heating a combination of the print dots. During each printing process, the print dots are supplied with a specific voltage facilitating a heating process and resulting in the corresponding area on the label turning black. Due to this repetitive printing process, the print dots undergoes a finite number of heat cycles before reaching its predetermined limit and after that the print dots are deemed non-functional. Therefore, the customer is required to replace the entire printhead with a new one to continue label printing, due to the failure of few print dots, despite the rest of components of the printhead, such as circuit board, controller, heat sink or shield, are operational.

Applicant has identified a number of deficiencies and problems associated with conventional printing apparatuses. Through applied effort, ingenuity, and innovation, many of these identified problems have been solved by developing solutions that are included in embodiments of the present disclosure, many examples of which are described in detail herein.

### SUMMARY OF THE DISCLOSURE

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

Printing apparatuses and associated printheads are disclosed herein for prolonging the life of a printhead. In an example embodiment, a printhead comprising a first burn line of heating elements disposed on a first surface of the printhead and a second burn line of heating elements disposed on a second surface of the printhead. The second surface is opposite to the first surface. Thereafter, one of the first burn line of heating elements or the second burn line of heating elements is configured to perform a printing operation.

In some embodiments, a switch element is electrically coupled to the first burn line of heating elements and the second burn line of heating elements. The switch element selects one of the first burn line of heating elements or the second burn line of heating elements to perform the printing operation. In some embodiments, the switch element is manually actuated based on a user input.

In some embodiments, one or more sensors are configured to generate an orientation signal based on an orientation of the printhead. The orientation signal is deterministic of the orientation of the printhead. In some embodiments, a controller is communicatively coupled with the one or more sensors. The controller is configured to activate one of the first burn line of heating elements or the second burn line of heating elements based on the orientation signal.

In some embodiments, the printhead is configured to be received within a printhead bracket in one or more orientations. In some embodiments, a plurality of fasteners are configured to secure the printhead within the printhead bracket in a first orientation and in a second orientation. In some embodiments, the first orientation and the second orientation of the printhead is modified by a user. A user unfastens the plurality of fasteners, removes the printhead from the printhead bracket, reorients the printhead, attaches the reoriented printhead to the printhead bracket and fastens the plurality of fasteners.

In another example embodiment, a printing apparatus is disclosed. The printing apparatus comprises a printhead bracket and a printhead configured to be received in the printhead bracket in at least one of a first orientation and a second orientation. The printhead comprises a first burn line of heating elements disposed on a first surface of the printhead and a second burn line of heating elements disposed on a second surface of the printhead. The second surface is opposite to the first surface. Thereafter, one of the first burn line of heating elements or the second burn line of heating elements is configured to perform a printing operation.

In some embodiments, the printhead further comprises a switch element electrically coupled to the first burn line of heating elements and the second burn line of heating elements. The switch element selects one of the first burn line of heating elements or the second burn line of heating elements to perform the printing operation. In some embodiments, the switch element is manually actuated based on a user input.

In some embodiments, the printhead further comprises one or more sensors configured to generate an orientation signal based on an orientation of the printhead. The orientation signal is deterministic of the orientation of the printhead. In some embodiments, the printhead further comprises a controller communicatively coupled with the one or more sensors. The controller is configured to activate one of the first burn line of heating elements or the second burn line of heating elements based on the orientation signal. In some embodiments, the printhead further comprises a first connector and a second connector. The first connector is coupled to a first mating connector and the second connector is coupled to a second mating connector. Further, the first connector is configured for sending data to the printhead and the second connector is configured to supply power to the printhead.

In another example embodiment, a method for operating a printing apparatus is disclosed. The method comprises determining, by a controller, an orientation of a printhead in the printing apparatus. The printhead comprises a first burn line of heating elements and a second burn line of heating elements disposed on a first surface of the printhead and a second surface of the printhead, respectively. The method further comprises performing, by the controller, a printing operation using one of the first burn line of heating elements or the second burn line of heating elements based on the orientation of the printhead.

In some embodiments, the method comprises activating/operating a switch element to toggle between the first burn line of heating elements and the second burn line of heating elements. The switch element executes switching of the first burn line of heating elements and the second burn line of heating elements to perform the printing operation. The method further comprises receiving an orientation signal from one or more sensors in the printhead. The orientation signal is deterministic of the orientation of the printhead. Further, the method comprises performing the printing operation using the first burn line of heating elements in an instance in which the printhead is in a first orientation, and performing the printing operation using the second burn line of heating elements in an instance in which the printhead is in a second orientation.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a printing apparatus, in accordance with the present disclosure;

FIG. 2A illustrates a side view of a printhead of the printing apparatus, in accordance with the present disclosure;

FIG. 2B illustrates a top view of the printhead of the printing apparatus, in accordance with the present disclosure;

FIG. 2C illustrates a bottom view of the printhead of the printing apparatus, in accordance with the present disclosure;

FIG. 3 illustrates a perspective view of the printing apparatus, in accordance with an example embodiment of the present disclosure;

FIG. 4 illustrates a perspective view of a printhead assembly of the printing apparatus, in accordance with an example embodiment of the present disclosure;

FIGS. 5A-5C illustrate movement of the printhead between a first orientation and a second orientation, in accordance with an example embodiment of the present disclosure;

FIG. 6 illustrates a thermal printhead circuit of the printing apparatus, in accordance with an example embodiment of the present disclosure;

FIG. 7 illustrates a flowchart showing steps of a method for operating the printing apparatus, in accordance with an example embodiment of the present disclosure;

FIG. 8A illustrates an isometric view of the printhead having a first surface, in accordance with an example embodiment of the present disclosure;

FIG. 8B illustrates an isometric view of the printhead having a second surface, in accordance with an example embodiment of the present disclosure;

FIG. 9A illustrates an isometric view of the printhead having the first surface, in accordance with an example embodiment of the present disclosure;

FIG. 9B illustrates an isometric view of the printhead having the second surface, in accordance with an example embodiment of the present disclosure;

FIG. 10A illustrates a perspective view of the printhead attached with one or more sensors facing towards the printhead bracket, in accordance with an example embodiment of the present disclosure; and,

FIG. 10B illustrates another perspective view of the printhead attached with one or more sensors facing opposite to the printhead bracket, in accordance with an example embodiment of the present disclosure.

### DETAILED DESCRIPTION

The exemplary embodiments described herein provide detail for illustrative purposes and are subject to many variations in structure and design. It should be appreciated, however, that the embodiments are not limited to a particularly disclosed embodiment shown or described. It is understood that various omissions and substitutions of equivalents are contemplated as circumstances may suggest or render expedient, but these are intended to cover the application or implementation without departing from the spirit or scope of the claims.

Also, it is to be understood that the phraseology and terminology used herein is for the purpose of description and should not be regarded as limiting. The terms “a,” “an,” and “the” herein do not denote a limitation of quantity, but rather denote the presence of at least one of the referenced object. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Like numerals represent like parts in the figures.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

Various embodiments of the present disclosure disclose a printhead used in a thermal printer having multiple resistors or heating elements in a burn line disposed on a substrate. Such heating elements may be energized to perform a printing operation with the passage of electric current for controlled time periods. In reference to conventional techniques, the exhaustion of the burn line indicates the end of life of the printhead such that a user is required to discard the exhausted printhead and required to obtain a new replacement printhead. Therefore, the completion of the printing job may also be delayed resulting in productivity and efficiency losses. Additionally, these conventional printheads result in hardware wastage, as the majority of the printhead components (i.e., a heat sink, a substrate, and a printed circuit board) continue to perform their respective functionalities, the printhead must be disposed of when only a single component (i.e., the burn line) has deteriorated. In some embodiments, the printed circuit board may be flexible. Thus, the present disclosure discloses a printhead that has at least one additional burn line. Such additional burn line enhances the printing life and capacity of the disclosed printhead while retaining a similar footprint as compared to the conventional printheads.

The printhead disclosed in some example embodiments herein reduces hardware waste by re-using the remaining components (i.e., the heat sink, the substrate, and/or the printed circuit board) on the printhead after the first burn line of heating elements has deteriorated or worn out. In some embodiments, the depth of the disclosed printhead is comparatively bigger than existing printheads to accommodate an additional burn line and a larger heat sink. The larger heat sink may function to dissipate more heat from the disclosed printhead to further prolong the life of the printhead. Additionally, in some example embodiments, the disclosed printhead may be implemented with various computer-implemented components or software applications. Such implementation may allow for increased processing speeds and reduced memory requirements of the printing apparatus. In some examples, the disclosed printhead may operate to increase the life of the printhead to at least twice that of existing printing apparatuses such that the productivity and efficiency of the printing operation is significantly increased.

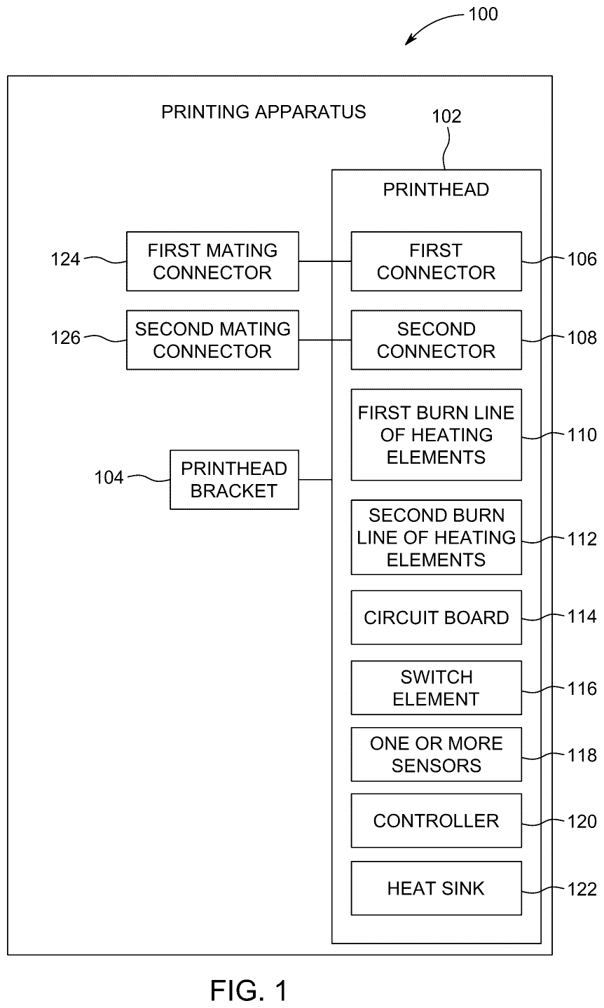

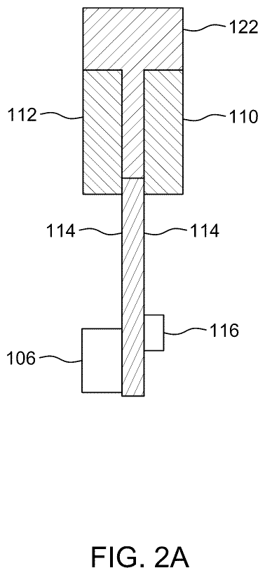

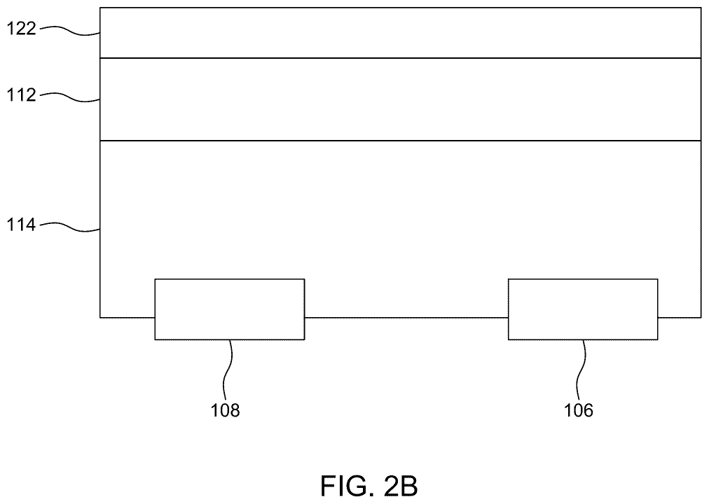

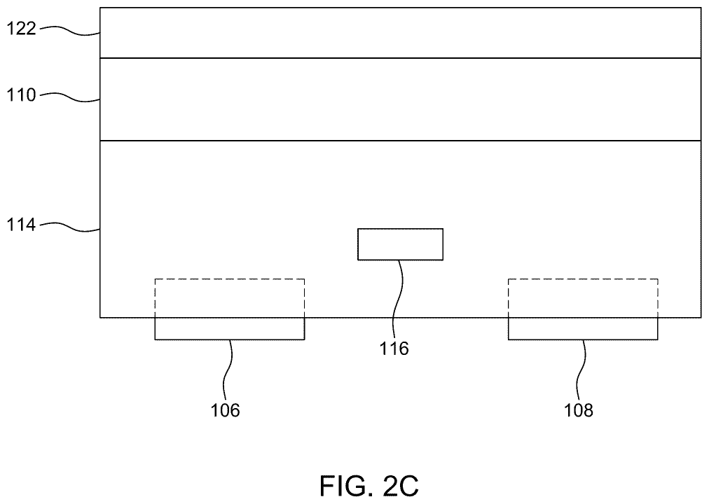

FIG. 1 illustrates a block diagram of a printing apparatus 100, in accordance with one or more embodiments of the present disclosure. FIGS. 2A-2C are described in conjunction with FIG. 1.

The printing apparatus 100 may comprise a printhead 102 and a printhead bracket 104. The printhead 102 may be secured within the printhead bracket 104 via a plurality of fasteners (not shown). The plurality of fasteners may include a plurality of screws (not shown) and a plurality of slots (not shown). In some embodiments, the printhead 102 may comprise a first connector 106 and a second connector 108. Further, the printhead 102 may comprise a first burn line of heating elements 110, a second burn line of heating elements 112, a circuit board 114, a switch element 116, one or more sensors 118, a controller 120 and a heat sink 122. In some embodiments, the first connector 106 may be connected to a first mating connector 124 for sending data to the printhead 102. Further, the second connector 108 may be connected to a second mating connector 126 for supplying power to the printhead 102. In one embodiment, the first connector 106 and the second connector 108 may be positioned over the printhead 102 in a same plane as shown in FIG. 2B. In another embodiment, the first connector 106 and the second connector 108 may be positioned over the printhead 102 in the opposite planes.

Further, the printhead 102 may be pivotally mounted in the printing apparatus 100. In some embodiments, the printhead 102 may form an integral unit or module that is bolted to a casting (not shown) to secure the printhead 102 within the printing apparatus 100. As discussed, the printhead 102 may be secured within the printhead bracket 104 using the plurality of screws and the plurality of slots. In one embodiment, the printhead 102 may be secured within the printhead bracket 104 in a first orientation and in a second orientation. The orientation of the printhead 102 may be changed by unfastening the plurality of screws from the plurality of slots, changing the orientation of the printhead 102 from the first orientation to the second orientation or vice versa, attaching the reoriented printhead 102 to the printhead bracket 104 and fastening back the plurality of screws with the plurality of slots.

Further, upon attaching the printhead 102, the first burn line of heating elements 110 or the second burn line of heating elements 112 may produce heat energy by receiving electrical energy from the printing apparatus 100. In some embodiments, the produced heat energy may be facilitated by a process of resistance. It may be noted that an electric current passing through the first burn line of heating elements 110 and the second burn line of heating elements 112 may develop resistance, and thereby may produce heat.

Further, the first burn line of heating elements 110 may be fabricated on a first surface (not shown) of the printhead 102 and the second burn line of heating elements 112 may be fabricated on a second surface (not shown) of the printhead 102. In some embodiments, the second surface may be opposite to the first surface.

In some embodiments, the printhead 102 may comprise the circuit board 114. The circuit board 114 may provide a base for fabricating one or more components of the printhead 102. Further, the first burn line of heating elements 110 and the second burn line of heating elements 112 may be electrically coupled to the switch element 116, as shown in FIGS. 2A and 2B. The switch element 116 may select one of the first burn line of heating elements 110 or the second burn line of heating elements 112 to perform a printing operation. In some embodiments, the switch element 116 may be manually operated by the user to select between the first burn line of heating elements 110 or the second burn line of heating elements 112. In some embodiments, the switch element 116 may be referred as a toggle switch to control which of the first burn line of heating elements 110 or the second burn line of heating elements 112 may be used for the printing operation.

Further, the printhead 102 may comprise the one or more sensors 118. The one or more sensors 118 may be configured to determine the orientation of the printhead 102 or the circuit board 114. Based on the orientation of the printhead 102, the one or more sensors 118 may generate an orientation signal. The orientation signal may be deterministic of the orientation of the printhead 102. In some embodiments, the one or more sensors 118 may include, but are not limited to, position sensors, such as, accelerometers, gyroscopes and magnetometers.

Further, the printhead 102 may comprise the controller 120 communicatively coupled to the one or more sensors 118. In some embodiments, the controller 120 may receive the orientation signal from the one or more sensors 118 and determine which of the burn line i.e. the first burn line of heating elements 110 or the second burn line of heating elements 112 may be correctly positioned to be activated. In some embodiments, the controller 120 may be configured to activate only one of the first burn line of heating elements 110 or the second burn line of heating elements 112 based on the orientation signal.

In some example embodiment, the switch element 116 may be selected to activate the first burn line of heating elements 110, and thus may prevent the second burn line of heating elements 112 from operating. Similarly, the switch element 116 may be selected to activate the second burn line of heating elements 112, and thus may prevent the first burn line of heating elements 110 from operating. In some another example embodiments, the one or more sensors 118 may be designed to prevent the second burn line of heating elements 112 from operating in the first orientation and prevent the first burn line of heating elements 110 from operating in the second orientation based on the generated orientation signal, as discussed above.

In an exemplary embodiment of the present disclosure, the printhead 102 may be oriented in the first orientation that is the top view of the printhead 102, as shown in FIG. 2B. The controller 120 of the printing apparatus 100 may selectively activate the first burn line of heating elements 110, when the printhead bracket 104 receives the printhead 102 in the first orientation to carry out the printing operation. In the first orientation, the printhead 102 may be fixed within the printhead bracket 104.

In another exemplary embodiment of the present disclosure, the printhead 102 may be oriented in the second orientation that is the bottom view of the printhead, as shown in FIG. 2C. The controller 120 of the printing apparatus 100 may selectively activate the second burn line of heating elements 112, when the printhead bracket 104 receives the printhead 102 in the second orientation to carry out the printing operation. In the second orientation, the printhead 102 may be fixed within the printhead bracket 104.

Further, the first burn line of heating elements 110 and the second burn line of heating elements 112 may each have a different printing life that the controller 120 of the printing apparatus 100 may be set up to monitor. The controller 120 of the printing apparatus 100 may be further designed to detect one or more alert circumstances related to the first burn line of heating elements 110 in response to the monitoring of the printing life of the first burn line of heating elements 110.

In some embodiments, an alert condition may be related to the first burn line of heating elements 110 being in a malfunctioned state. For instance, the first burn line of heating elements 110 may be in the malfunction state when it is overused, underused, overheated, under-heated, and/or inoperative, allowing an incorrect printing operation to be carried out. In alternative implementations, the alert condition may be associated with the first burn line of heating elements 110 reaching the end of its useful printing life.

In one embodiment, the first connector 106 may also correspond to a data in/out ports. The data in/out ports are configured for sending data to the first burn line of heating elements 110 and the second burn line of heating elements 112. In another embodiment, the data in/out ports may be configured for receiving one or more parameters of the printhead 102. The one or more parameters may include health information of the printhead 102, real time temperature of the printhead via an integrated thermistor (not shown), etc. In one embodiment, the second connector 108 may also correspond to power pins. The power pins may be configured to supply power to the printhead 102. Further, the printhead 102 may comprise the heat sink 122 to absorb heat from the first burn line of heating elements 110 and the second burn line of heating elements 112. In some embodiments, the heat sink 122 may act as a shield for the first burn line of heating elements 110 and the second burn line of heating elements 112.

It will be apparent to one skilled in the art that above-mentioned components of the printing apparatus 100 have been provided only for illustration purposes, without departing from the scope of the disclosure.

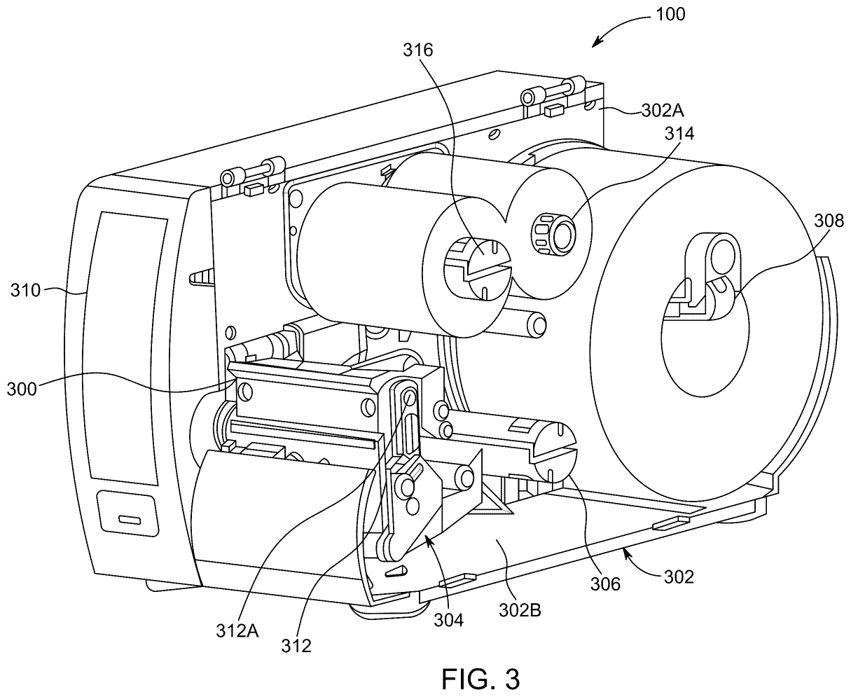

FIG. 3 illustrates a perspective view of the printing apparatus 100, in accordance with an example embodiment of the present disclosure. FIG. 3 is described in conjunction with FIGS. 1-2B.

The printing apparatus 100 may comprise a printhead assembly 300. The printhead assembly 300 may comprise the printhead 102, as discussed above in conjunction with FIGS. 1-2B. The printhead assembly 300 and the printhead 102 may be described in greater detail in the later part of the detailed description.

The printing apparatus 100 may comprise a casting 302, a support block assembly 304, a thermal ink printer media take-up assembly module 306, an ink ribbon printer media take-up assembly module (not shown), a media supply hub 308, a display assembly 310, a printhead latch 312, a rod (not shown), a ribbon supply assembly 314, and a ribbon take-up assembly 316.

In some embodiments, the casting 302 may be detachably attached with one or more components of the printing apparatus 100. The one or more components may allow the printing apparatus 100 to be easily and quickly convert from an ink ribbon printer to a thermal ink printer and vice-versa by installing the printhead 102 and the ink ribbon printer media take-up assembly module into the printing apparatus 100. Further, the printing apparatus 100 may be configured with different circuit boards for selectively controlling operation of the printing apparatus 100. In some example embodiments, the different circuit boards may convert the printing apparatus 100 from the thermal ink printer to the ink ribbon printer or vice-versa. For example, the ink ribbon printer may comprise a circuit board different from the circuit board integrated inside the thermal ink printer. In some other embodiments, the circuit board of the printing apparatus 100 may also be configured to operate the ink ribbon printer and thermal ink printer without requiring two different circuit boards.

In some embodiments, the casting 302 may support the printing apparatus 100. The casting 302 may include a central support member 302A and a base member 302B. The central support member 302A and the base member 302B may be monolithically formed from a heat conductive material, such as cast aluminum, ceramics, plastics, sheet metal, and the like. In some example embodiments, casting of the central support member 302A and the base member 302B monolithically may improve the heat dissipation of the printing apparatus 100. It may be noted that the casting 302 may include various recesses configured to receive support block assemblies in a specific orientation such that when each of the assemblies may be secured to the casting 302, the assemblies are supported in an operative configuration. In some embodiments, the printhead bracket 104 may be designed as a support housing for the printhead 102, which is intended to be fixed to an engagement element (not shown) of the casting 302.

In some embodiments, the support block assembly 304 may include various support portions to be releasably engaged with a portion of the printhead latch 312. The support block assembly 304 may include a platen mounting block (not shown), a platen assembly (not shown) having a platen roller (not shown), a retainer bracket (not shown), a media guide (not shown), and a tear bar (not shown). In some embodiments, the platen roller in the platen assembly may be a motor generated driver (not shown). The platen roller may drive the media forward/backward past the printhead 102 and provide counter-pressure. In some embodiments, the support block assembly 304 may be a replaceable part in the printing apparatus 100.

Further, the media take-up assembly module 306 for the thermal ink printer may contain at least a hub assembly (not shown) adapted to hold a media take-up roll. Further, the ink ribbon printer media take-up assembly module may contain at least one ribbon supply assembly 314. Further, the media supply hub 308 may have a hub (not shown) and an adjustable retaining member (not shown). The adjustable retaining member may be rotated back to a position perpendicular to the hub and slid into contact with the media supply roll to hold the media supply roll in place once it has been placed on the hub.

In some embodiments, the display assembly 310 may further include a display, such as, a light-emitting diode (LED) display, an organic light-emitting diode (OLED) display, a liquid-crystal display (LCD), a cathode ray tube (CRT), or the like. In certain embodiments, the display assembly 310 may also include a display enclosure (not shown). The display assembly 310, may further include operational and menu keys that may enable the user to modify the operating settings of the printing apparatus 100, and may indicate the printing status of the printing apparatus 100. The display assembly 310 may be set up to show instructions and operating parameters in a variety of languages. Further, the display assembly 310 may be set up to show the orientation status and the malfunctioning status of the printhead 102.

Further, the printhead latch 312 may be configured to allow the printhead assembly 300 to become pivotally movable around the rod, when the printhead latch 312 is disengaged from the support block assembly 304. For instance, the printhead latch 312 is released from the support block assembly 304 when pressure is applied to a button (not shown) of the printhead latch 312. In case of performing any maintenance operations, the printhead 102 may be pivoted away from its default or ready position.

Further, the printing apparatus 100 may further comprise electrical and drive components. The electrical and drive components may be configured to send information related to position and movement of the printhead 102 according to the image formation of a document or a matter that is to be printed. To operate a particular printing program, alternatively, software may be downloaded via a device such a COM port or CUPS printer driver. The printing apparatus 100, as shown in FIG. 3, may be frequently set up for use in industrial or commercial printing applications. Additionally, the present invention allows for the possibility that the printing apparatus 100 may also be used for desktop or personal usage.

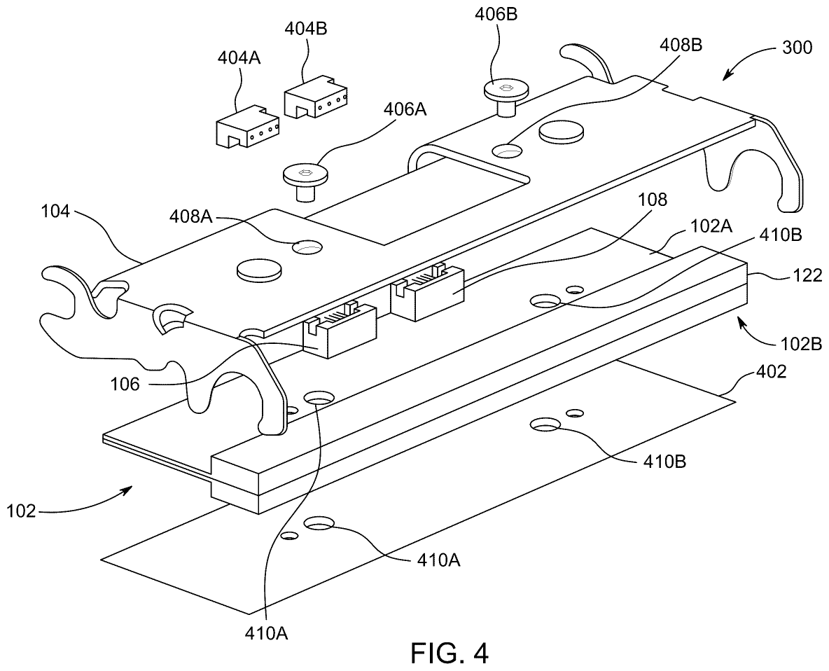

Referring to FIG. 4, a perspective view of the printhead 102 in the printhead assembly 300 is disclosed, in accordance with an example embodiment of the present disclosure. FIG. 4 is described in conjunction with FIGS. 1-3.

As discussed, the printing apparatus 100 may comprise the printhead 102 and the printhead bracket 104. Further, the printing apparatus 100 may comprise a printhead plate 402. In some implementations of the printhead 102, the printhead plate 402, and the heat sink 122 may also be present. Further, the printhead 102 may comprise a first surface 102A and a second surface 102B. It may be noted that the first surface and the second surface of the printhead 102, as described in earlier embodiments, may be identical to the first surface 102A and the second surface 102B of the printhead 102 and may be opposite to each other, as shown in FIG. 4. In some example embodiments, the printhead 102 may be positioned in the first orientation such that the first surface 102A having the first burn line of heating elements 110 may be activated for the printing operation. Further, the media, such as the label stock, may be in direct contact with the first burn line of heating elements 110 of the first surface 102A of the printhead 102.

Further, the printing apparatus 100 may, in some instances, be set up as the thermal transfer printing apparatus or a direct thermal printing apparatus. As an example, the label stock that may be specifically processed and includes dyes designed to look black when heat and pressure are applied, may be used for direct thermal printing. As discussed above, the printing apparatus 100 may be set up as the thermal transfer printing apparatus or the ink ribbon printer in a different alternative form. For instance, in order to print using thermal transfer, a ribbon substrate with ink on it may be used. The ink may be transferred to a media by means of heat and/or pressure. In such an example, the ink ribbon and the media, such as the label stock, may both be in direct contact with the first surface 102A of the printhead 102.

In one embodiment, the first surface 102A of the printhead 102 may include the first connector 106 and the second connector 108 as shown in FIG. 4. The first connector 106 and the second connector 108 may be connected to a first mating connector 404A and a second mating connector 404B respectively when the printhead 102 is secured within the printhead bracket 104 in the first orientation or the second orientation. It may be noted that the first mating connector 124 and the second mating connector 126 shown in FIG. 1 may be identical as the first mating connector 404A and the second mating connector 404B in FIG. 4 respectively.

In an alternative embodiment, the first surface 102A of the printhead 102 may include the first connector 106 and the second surface 102B may include the second connector 108. In another alternative embodiment, the printhead 102 may be fixed inside the printhead bracket 104 in either the first orientation or the second orientation to carry out the printing operation using only one connector. Further, the printhead 102 and the printhead plate 402 may be fixed to the printhead bracket 104 in the first orientation and the second orientation by a plurality of screws 406A and 406B which may be positioned in the plurality of slots i.e. a first set of slots 408A and 408B and a second set of slots 410A and 410B. In some embodiments, the first set of slots 408A and 408B may be fabricated over the printhead bracket 104. The second set of slots 410A and 410B may be fabricated over the printhead 102 and the printhead plate 402. Further, the first surface 102A of the printhead 102 may support the heat sink 122 and define a housing with a gripping surface designed to firmly hold the printhead 102 to an interface (e.g., through a magnet, hook and loop connections, or similar means). To make it easier to remove heat produced by the printhead 102 during printing, the heat sink 122 may be made of an extruded heat conductive material, such as aluminum. Additionally, other materials, such as ceramics, plastics, and sheet metal, may also be employed to create the heat sink 122 without departing from the scope of the disclosure.

Although the printhead 102, the printhead plate 402, and/or the printhead bracket 104 are shown in the following description as having rectangle shapes, the present disclosure contemplates that other shapes, such as a square shape, may be used without departing from the scope of the disclosure. As a result, there could be variations in the shape with equal edges, at least four substrates, one adjacent to each of the four edges, four burn lines, one adjacent to each edge of each substrate, and four connectors, one corresponding to each edge, may be implemented on each of the printhead plate's two surfaces.

As discussed, the printhead 102 and the printhead plate 402 may be positioned in the first orientation, alternatively, the printhead 102 and the printhead plate 402 may also be positioned in the second orientation to define the working of the second burn line of heating elements 112. Successively, the printhead 102 and the printhead plate 402 may be fixed within the printhead bracket 104 in the second orientation by the plurality of screws 406A and 406B which may be positioned in the first set of slots 408A and 408B and the second set of slots 410A and 410B fabricated over the printhead 102 and the printhead plate 402.

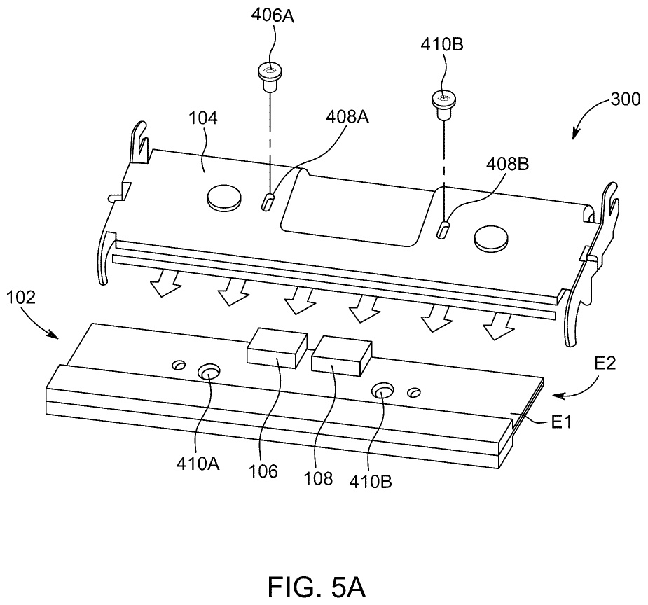

Referring to FIG. 5A, a top view of the printhead 102 in an initial orientation, i.e. the first orientation for performing the printing operation, is disclosed. FIGS. 5B-5C illustrate intermediate positions of switching the printhead 102 from the first orientation to the second orientation in accordance with an example embodiment of the present disclosure. FIGS. 5A-5C are described in conjunction with FIGS. 1-4.

In some example embodiments, while using the printhead 102 in the first orientation, a media label (not shown) may be exposed to the first burn line of heating elements 110, and the second burn line of heating elements 112 may be covered by the surface of the printhead bracket 104 that receives the printhead 102. As a result, the second burn line of heating elements 112 may not be in operation while the first burn line of heating elements 110 may be in operation. Further, the first burn line of heating elements 110 may be disposed on the first surface of the printhead 102, shown by ‘E1’ in FIG. 5A.

While performing the printing operation using the first burn line of heating elements 110, the first burn line of heating elements 110 may either get damaged or the printing lifecycle of the first burn line of the heating elements 110 may be completed. Thereafter, the first connector 106 and the second connector 108 of the printhead 102 may be detached from the first mating connector 404A and the second mating connector 404B for switching the orientation, for example, from the first orientation to the second orientation. Further, the plurality of screws 406A and 406B may be removed from the first set of slots 408A and 408B in the printhead bracket 104 and the second set of slots 410A and 410B in the printhead 102 and the printhead plate 402. Successively, the user may manually release the printhead 102 from the printhead bracket 104 in the first orientation using the switch element 116. In some embodiments, the controller 120 may be set up to trigger the movement of the printhead 102 from the first orientation to the second orientation, using the switch element 116.

Thereafter, due to the damage or the end of the printing lifecycle of the first burn line of heating elements 110, the user may reorient the printhead 102 in the second orientation as shown in FIG. 5B. Further, the second burn line of heating elements 112 of the printhead 102 may be disposed on the second surface of the printhead 102, shown by ‘E2’. Further, as shown in FIG. 5C, the printhead bracket 104 may receive the printhead 102 in the second orientation with the second burn line of the heating elements 112 configured to be activated for performing the printing operation. Further, the printhead bracket 104 may secure the printhead 102 and the printhead plate 402 by positioning the plurality of screws 406A and 406B within the first set of slots 408A and 408B formed in the printhead bracket 104 and the second set of slots 410A and 410B formed in the printhead 102 and the printhead plate 402.

In some embodiments, the printhead 102 received by the printhead bracket 104 in the first orientation may be automatically released from the printhead bracket 104. In some embodiments, the printhead 102 may be automatically rotated by a defined angular movement. In some other embodiments, the printhead 102 may be automatically secured within the printhead bracket 104 in the second orientation. Such automatic release and securing of the printhead 102 may be facilitated using magnetic fastening mechanisms. In some embodiments, the magnetic fastening mechanisms may be integrated between the different components in such a case.

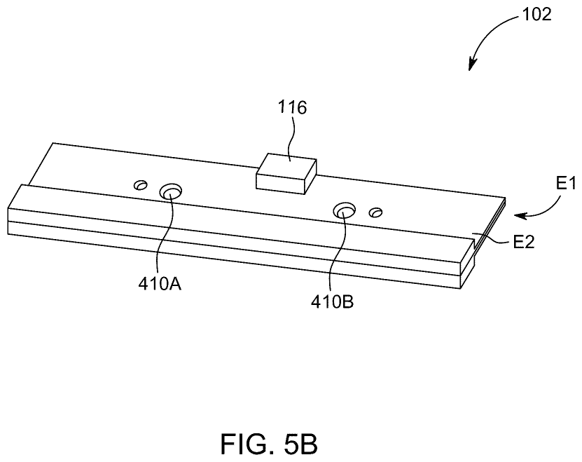

Referring to FIG. 6, a thermal printhead circuit 600 of the printing apparatus 100 is disclosed, in accordance with an example embodiment of the present disclosure. FIG. 6 is described in conjunction with FIGS. 1-4.

In some embodiments, the circuit board 114 described in previous embodiments may also be termed as the thermal printhead circuit 600. The thermal printhead circuit 600 comprises a DATA IN 1 602A, a DATA IN2 602B, a CLOCK 604, a LATCH 606, a STROBE 1 608A, a STROBE 2 608B, CONNECTORS 1-5 610 and a thermistor 612. The DATA IN 1 602A and the DATA IN 2 602B may be control lines. A data representing the image or text that is to be printed by the printing apparatus 100 may be sent by the DATA IN 1 602A and the DATA IN2 602B. The data may be sent in bits with “1” indicating the elements needs to turned on while the “0” represents the elements that should be left unpowered for situation where no data is to be printed.

Further, the CLOCK 604 may be a timing signal that may be configured to synchronize the operations of the printhead 102 with other components in the printing apparatus 100. The CLOCK 604 may operate at a specific frequency and determine the timing intervals for various operations, such as data transfer and activation of the first burn line of heating elements 110 or the second burn line of heating elements 112.

Further, the LATCH 606 may capture or hold the data being transmitted to the printhead 102 from the direction of first burn line of heating elements 110 to the second burn line of heating elements 112. It may be noted that the direction of the data transferred between the first burn line of heating elements 110 and the second burn line of heating elements 112 may be based on the orientation of the printhead 102. In an instance, when the printhead 102 is secured within the printhead bracket 104 in the first orientation, the data may transfer from the first burn line of heating elements 110 to the second burn line of heating elements 112. In another instance, when the printhead 102 is secured within the printhead bracket 104 in the second orientation, the data may transfer from the second burn line of heating elements 112 to the first burn line of heating elements 110. In one embodiment, the LATCH 606 may work in conjunction with the CLOCK 604. In one embodiment, when the LATCH 606 may be activated, the LATCH 606 “Latches” or stores the data present at that moment, ensuring that it remains stable during subsequent operations. Further, the STROBE 1 608A and the STROBE 2 608B may be a control signal to trigger the actual printing or activation of the selected one of the first burn line of heating elements 110 or the second burn line of heating elements 112. In some embodiments, when the STROBE 1 608A and the STROBE 2 608B may be activated, the STROBE 1 608A and the STROBE 2 608B may instruct the printhead 102 to apply heat to the selected pixels or dots based on the data that has been previously latched.

Further, the CONNECTORS 1-5 610 may connect to an EEPROM IC, which may be configured for storing the information of the printhead 102. Further, the thermistor 612 may be a temperature sensor configured to monitor the temperature of the printhead 102. In some embodiments, the thermistor 612 may be DS18B20 sensor. It may be noted that the STROBE 1 608A and the STROBE 2 608B may be responsible for heating the Print Dot Strip. Further, the STROBE 1 608A and the STROBE 2 608B may be conditionally (i.e., based on the orientation of printhead 102) activated to actuate either the first burn line of heating elements 110 or the second burn line of heating elements 112. The STROBE 1 608A and the STROBE 2 608B may be controlled with the help of the switch element 116.

In one embodiment, the data received on the DATA IN 1 lines 602A and the DATA IN2 lines 602B may be serially loaded into one or more shift registers. Further, the CLOCK 604 may control the shifting of the data through the one or more shift registers with one bit at a time. Further, the data bits may be converted from a serial input to parallel outputs. It may be noted that the parallel outputs correspond to the column of the first burn line of heating elements 110 or the second burn line of heating elements 112. Further, once all the data bits are shifted into the one or more shift registers, the LATCH 606 may be activated. The activation of the LATCH 606 may cause the one or more shift registers to “Latch” or hold the current data values.

In some embodiments, when the LATCH 606 may transit from low to high, the latched data in the one or more shift registers may be transferred to the output stage. The output stage amplifies the data signals and activates one of the first burn line of heating elements 110 or the second burn line of heating elements 112 in the selected columns. Further, the heat may be generated and the thermal paper or coating may react to produce visible marks or images with the one of the first burn line of heating elements 110 or the second burn line of heating elements 112.

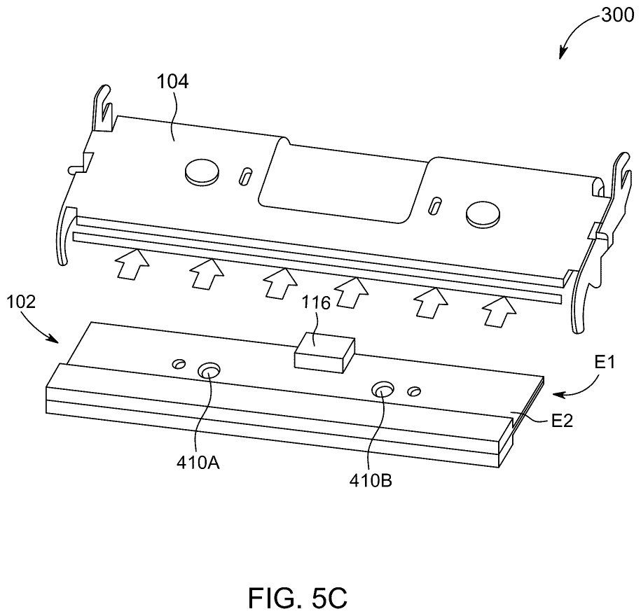

FIG. 7 illustrates a flowchart 700 showing steps of a method for operating the printing apparatus 100, in accordance with an example embodiment of the present disclosure.

At first, the controller 120 may determine the orientation of the printhead 102 in the printing apparatus 100, at step 702. In some embodiments, the controller 120 may receive an orientation signal from the one or more sensors 118 in the printhead 102. The orientation signal is deterministic of the orientation of the printhead 102. In some embodiments, the one or more sensors 118 may include, but are not limited to, position sensors, such as, accelerometers, gyroscopes and magnetometers.

For example, the printhead 102 is secured within the printhead bracket 104 in the first orientation. Upon activation of the printhead 102, a position sensor is activated to generate the orientation signal. Further, the controller 120 receives and processes the generated orientation signal and determines the printhead 102 is secured to the printhead bracket 104 in the first orientation.

Successively, the controller 120 may perform the printing operation using one of the first burn line of heating elements 110 or the second burn line of heating elements 112 based on the orientation of the printhead 102, at step 704. In some embodiments, the switch element 116 may be configured to be activated based on the user input to facilitate the printing operation using one of the first burn line of heating elements 110 or the second burn line of heating elements 112.

In some embodiments, the one or more sensors 118 may be configured to generate an orientation signal based on an orientation of the printhead 102. The orientation signal is deterministic of the orientation of the printhead 102. Further, the controller 120 communicatively coupled with the one or more sensors 118, may be configured to activate one of the first burn line of heating elements 110 or the second burn line of heating elements 112 based on the orientation signal.

In some example embodiments, the first burn line of heating elements 110 gets damaged while carrying the printing operation. Thereafter, the user may manually unfasten the plurality of screws 406A and 406B from the first set of slots 408A and 408B and the second set of slots 410A and 410B to reorient the printhead 102 from the first orientation to the second orientation. Further, the one or more sensors 118 may determine the orientation of the printhead 102 and generate the orientation signal, where the orientation signal corresponds to the printhead 102 placed in the second orientation. Based on the orientation determined by the one or more sensors 118, the controller 120 may generate a command to activate the second burn line of heating elements 112.

In some other example embodiments, the first burn line of heating elements 110 gets damaged while carrying the printing operation. Thereafter, the user may manually unfasten the plurality of screws 406A and 406B from the first set of slots 408A and 408B and the second set of slots 410A and 410B to reorient the printhead 102 from the first orientation to the second orientation. Thereafter, based on the user input, the switch element 116 switches the printhead 102 from the first orientation to the second orientation to perform the printing operation.

In some embodiments, the controller 120 performs the printing operation using the first burn line of heating elements 110 in an instance in which the printhead 102 is in the first orientation, and performs the printing operation using the second burn line of heating elements 112 in an instance in which the printhead 102 is in the second orientation.

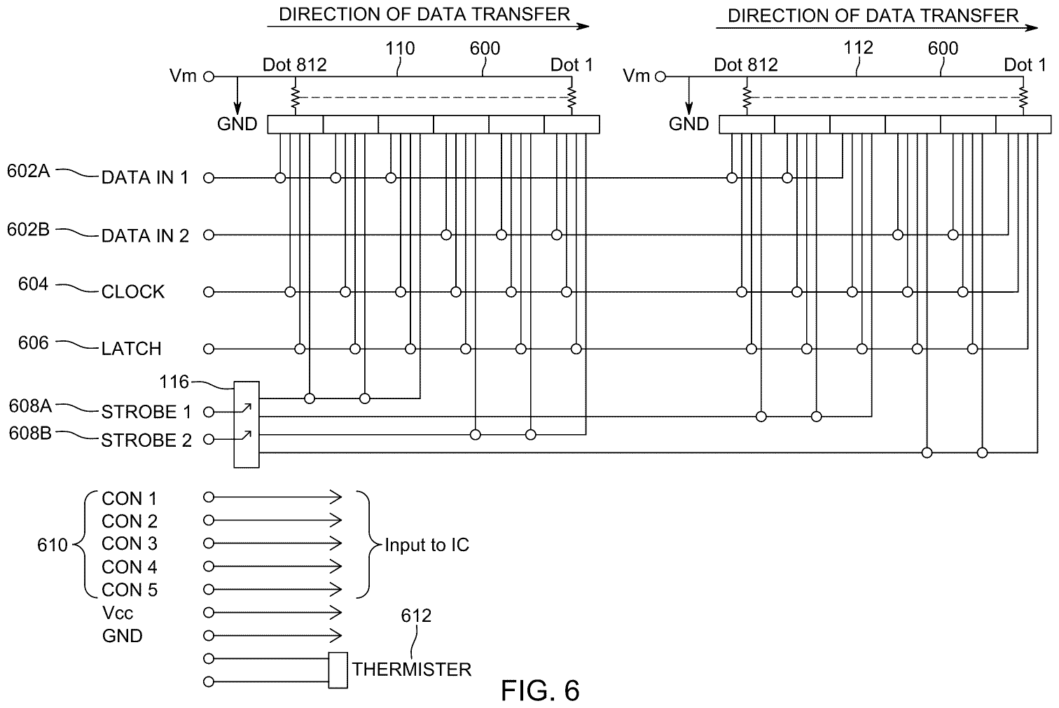

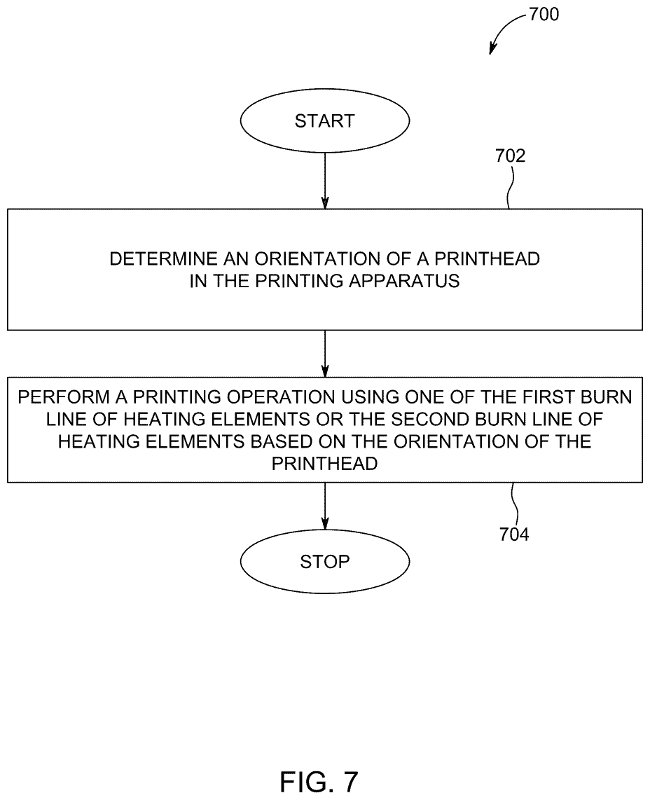

Referring to FIG. 8A, illustrates an isometric view of the printhead 102 having the first surface 102A, in accordance with an example embodiment of the present disclosure. FIG. 8B, illustrates an isometric view of the printhead 102 having the second surface 102B, in accordance with an example embodiment of the present disclosure. FIGS. 8A-8B are described in conjunction with FIGS. 1-4.

In some embodiments, the first surface 102A of the printhead 102 may include a first connector 106A and a second connector 108A. The first connector 106A and the second connector 108A may be connected to the first mating connector 404A and the second mating connector 404B respectively when the printhead 102 is secured within the printhead bracket 104 in the first orientation. Further, the second surface 102B of the printhead 102 may include a first connector 106B and a second connector 108B asymmetrically positioned opposite to the first connector 106A and the second connector 108A as shown in FIG. 8B. That is, the first connector 106B is located opposite to the second connector 108A, similarly, the second connector 108B is located opposite to the first connector 106A. Therefore, the first connector 106B and the second connector 108B may be connected to the first mating connector 404A and the second mating connector 404B respectively when the printhead 102 is secured within the printhead bracket 104 in the second orientation. It may be noted that the first connector 106 and the second connector 108 as described in FIG. 1 may be identical to the first connectors 106A and 106B and the second connectors 108A and 108B respectively.

In some embodiments, the asymmetric positioning of the first connector 106A and 106B in the opposite sides of the printhead 102 may allow the user to connect at least one of the first connector 106A or 106B with the first mating connector 404A irrespective of the orientation of the printhead 102. Similarly, the asymmetric positioning of the second connector 108A and 108B in the opposite side of the printhead 102 may allow the user to connect at least one of the first connector 108A or 108B with the second mating connector 404B irrespective of the orientation of the printhead 102. In some embodiments, the first mating connector 404A and the second mating connector 404B may be fixedly attached to the printhead assembly 300 and may not rotate during the change in the orientation of the printhead 102.

In order to change the orientation of the printhead 102, the user may first detach the first connector 106A and the second connector 108A from the first mating connector 404A and the second mating connector 404B respectively. Further, the user may rotate the printhead 102 towards the second surface 102B and attach the first connector 106B and the second connector 108B with the first mating connector 404A and the second mating connector 404B respectively to change the orientation of the printhead 102. As described in FIGS. 1-2B, the first connectors 106A and 106B may be connected with the first mating connector 404A for sending data to the first burn line of heating elements 110 and the second burn line of heating elements 112. Further, the second connectors 108A and 108B may be connected with the second mating connector 404B to supply power to the printhead 102.

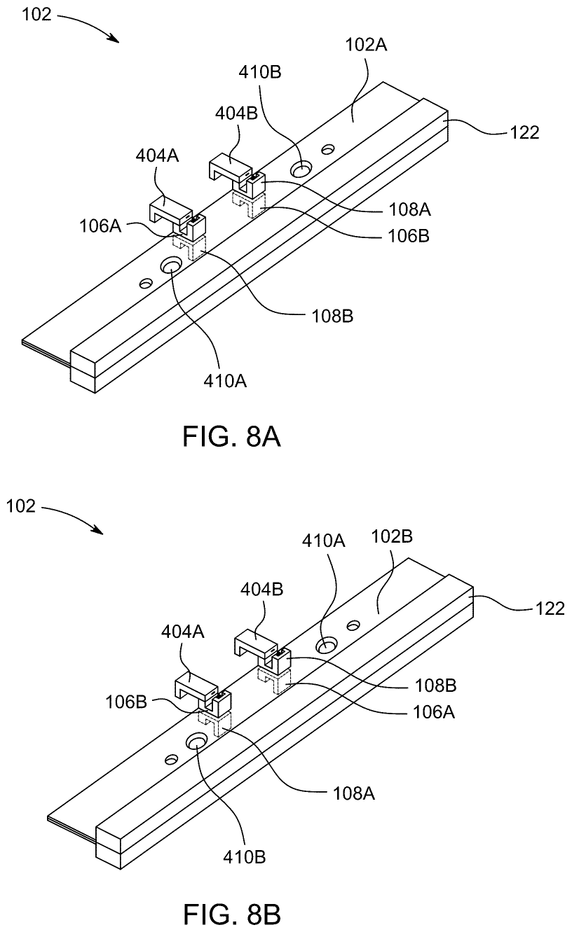

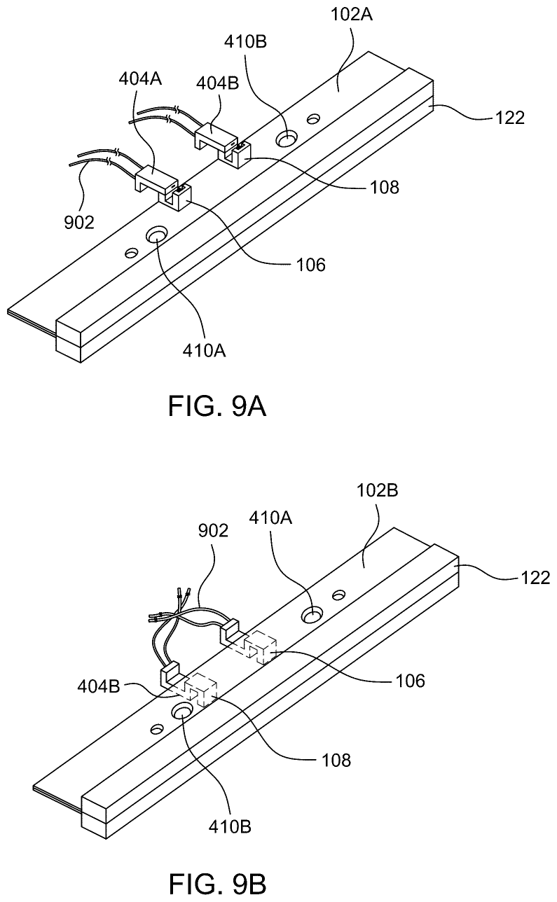

FIG. 9A illustrates an isometric view of the printhead 102 having the first surface 102A, in accordance with an example embodiment of the present disclosure. FIG. 9B, illustrates an isometric view of the printhead 102 having the second surface 102B, in accordance with an example embodiment of the present disclosure. FIGS. 9A-9B are described in conjunction with FIGS. 1-4.

In some embodiments, the first surface 102A of the printhead 102 may include the first connector 106 and the second connector 108s. In some embodiment, the first connector 106 may be connected to the first mating connector 404A and the second connector 108 may be connected to the second mating connector 404B when the printhead 102 is in the first orientation. Further, upon switching the printhead 102 from the first orientation to the second orientation, the first connector 106 and the second connector 108 may remain attached with the first mating connector 404A and the second mating connector 404B respectively. Thereby, during the change of the orientation of the printhead 102, the first connector 106 and the second connector 108 may rotate along the first mating connector 404A and the second mating connector 404B that may result in twisting a plurality of cables 902 as show in FIG. 9B. It may be noted that, the first mating connector 404A and the second mating connector 404B may not be fixedly connected to the printhead assembly 300 and may be linked with the printhead assembly 300 via the plurality of cables 902.

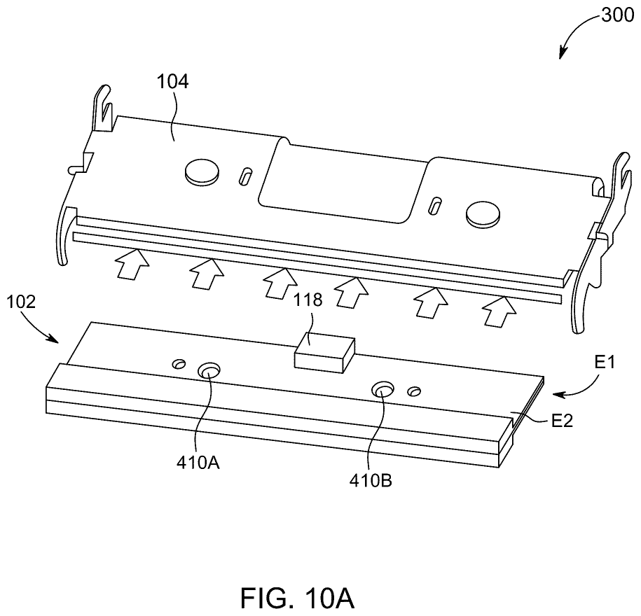

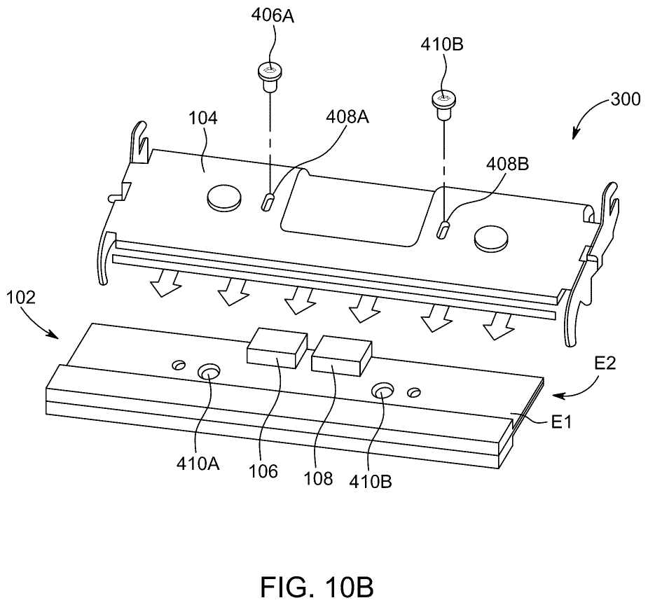

FIG. 10A illustrates a perspective view of the printhead 102 attached with one or more sensors 118 facing towards the printhead bracket 300, in accordance with an example embodiment of the present disclosure. FIG. 10B, illustrates the perspective view of the printhead 102 attached with the one or more sensors 118 facing opposite to the printhead bracket 300, in accordance with an example embodiment of the present disclosure.

In some embodiments, the first surface 102A of the printhead 102 may be attached with the one or more sensors 118. The one or more sensors 118 may be configured to determine the orientation of the printhead 102. The one or more sensors 118 may determine the printhead 102 positioned within the printhead bracket 300 in the first orientation or in the second orientation. The one or more sensors 118 may selectively be a proximity sensor, an infrared sensor, a hall effect sensor, a force sensor, a pressure senor and an orientation sensor. In some embodiments, the one or more sensors 118 may be configured to determine the orientation of the printhead 102 by determining the presence or absence of the printhead bracket 300. The one or more sensors 118 may use factors including electromagnetic waves, force or pressure that may be influenced by the presence or absence of the printhead bracket 300.

In one exemplary embodiment, the printhead 102 is mounted with the infrared sensor. The printhead 102 is fastened to the printhead bracket 300 in a manner such that the infrared sensor faces towards the printhead bracket 300 as shown in FIG. 10A. In such scenario, the infrared sensor detects the presence of the printhead bracket 300 by means of electromagnetic waves that are reflected from the printhead bracket 300. Further, the based on the reflected electromagnetic waves, the infrared sensor may generate and send a signal to the controller 120. The controller 120 based on the received signal may determine the orientation of the printhead i.e. the second orientation of the printhead 102. Further, based on the determined orientation, the controller may activate the second burn line of the heating elements 112.

In another exemplary embodiment, when the printhead 102 is fastened to the printhead bracket 300 in a manner such that the infrared sensor faces opposite to the printhead bracket 300 as shown in FIG. 10B. In such scenario, the infrared sensor detects the absence of the printhead bracket 300 by means of electromagnetic waves that are not reflected from the printhead bracket 300. Further, due to the absence of reflected electromagnetic waves, the infrared sensor may not generate and send the signal to the controller 120. The controller 120 based on the absence of the signal may determine the orientation of the printhead i.e. the first orientation of the printhead 102. Further, based on the determined orientation, the controller may activate the first burn line of the heating elements 110.

In another exemplary embodiment, the printhead 102 may be mounted with the orientation sensor. The orientation sensor may be configured to generate an orientation signal based on the orientation of the printhead 102. Further, the controller 120 may receive the orientation signal to determine the orientation of the printhead 102 and based upon which actuate the first burn line of heating elements 110 or the second burn line of heating elements.

Such method and printing apparatus disclose that the printhead 102 has at least twice the life as compared to printheads in existing printing apparatuses. In the existing printing apparatuses, the user is required to discard the printhead once the single burn line is exhausted, and the user is required to purchase a new printhead to replace the exhausted burn line in order to continue performing the printing operation. This may lead to unwanted hardware wastage as the rest of the components, such as the heat sink, the substrate, and/or the FPC in the printhead 102 may still serve their functionalities. In contrast, the disclosed printhead 102 provides re-usage of such hardware components and provides for an extended life to the printing apparatus. This may result in processing speeds and reduced memory requirements of the printing apparatus. In some example embodiments, such method of using the additional burn line increases productivity and efficiency gains associated with the printing operation.

As will be appreciated by one skilled in the art, aspects of the present disclosure may be embodied as a system, method, or computer program product. Accordingly, aspects of various embodiments may take the form of an entirely hardware embodiment, an entirely software embodiment (including firmware, resident software, micro-code, etc.) or an embodiment combining software and hardware aspects that may all generally be referred to herein as a “circuit,” “module”, “system” or “sub-system.” In addition, aspects of the present disclosure may take the form of a computer program product embodied in one or more computer readable medium(s) having computer readable program code embodied thereon.

The foregoing descriptions of specific embodiments have been presented for purposes of illustration and description. They are not intended to be exhaustive or to limit the embodiments to the precise forms disclosed, and obviously many modifications and variations are possible in light of the above teaching. The embodiments were chosen and described in order to best explain principles and practical applications thereof, and to thereby enable others skilled in the art to best utilize the various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims. The following claims are in no way intended to limit the scope of embodiments to the specific embodiments described herein.

What is claimed is:

1. A printhead comprising:
a first burn line of heating elements disposed on a first surface of the printhead; and,
a second burn line of heating elements disposed on a second surface of the printhead, wherein the second surface is opposite to the first surface, wherein one of the first burn line of heating elements or the second burn line of heating elements is configured to perform a printing operation.

2. The printhead of claim 1, further comprising a switch element electrically coupled to the first burn line of heating elements and the second burn line of heating elements, wherein the switch element selects one of the first burn line of heating elements or the second burn line of heating elements to perform the printing operation.

3. The printhead of claim 2, wherein the switch element is manually actuated based on a user input.

4. The printhead of claim 1, further comprising one or more sensors configured to generate an orientation signal based on an orientation of the printhead, wherein the orientation signal is deterministic of the orientation of the printhead.

5. The printhead of claim 4, further comprising a controller communicatively coupled with the one or more sensors, wherein the controller is configured to activate one of the first burn line of heating elements or the second burn line of heating elements based on the orientation signal.

6. The printhead of claim 1 wherein the printhead is configured to be received within a printhead bracket in one or more orientations.

7. The printhead of claim 6, further comprising a plurality of fasteners configured to secure the printhead within the printhead bracket in a first orientation and in a second orientation.

8. The printhead of claim 7, wherein the first orientation and the second orientation of the printhead is modified by a user, wherein the user unfastens the plurality of fasteners, removes the printhead from the printhead bracket, reorients the printhead, attaches the reoriented printhead to the printhead bracket and fastens the plurality of fasteners.

9. A printing apparatus comprising:
a printhead bracket; and,
a printhead configured to be received in the printhead bracket in at least one of a first orientation and a second orientation, wherein the printhead comprises:
a first burn line of heating elements disposed on a first surface of the printhead; and,
a second burn line of heating elements disposed on a second surface of the printhead, wherein the second surface is opposite to the first surface, wherein one of the first burn line of heating elements or the second burn line of heating elements is configured to perform a printing operation.

10. The printing apparatus of claim 9, wherein the printhead further comprises a switch element electrically coupled to the first burn line of heating elements and the second burn line of heating elements, wherein the switch element selects one of the first burn line of heating elements or the second burn line of heating elements to perform the printing operation.

11. The printing apparatus of claim 10, wherein the switch element is manually actuated based on a user input.

12. The printing apparatus of claim 9, wherein the printhead further comprises one or more sensors configured to generate an orientation signal based on an orientation of the printhead, wherein the orientation signal is deterministic of the orientation of the printhead.

13. The printing apparatus of claim 12, wherein the printhead further comprises a controller communicatively coupled with the one or more sensors, wherein the controller is configured to activate one of the first burn line of heating elements or the second burn line of heating elements based on the orientation signal.

14. The printing apparatus of claim 9, wherein the printhead comprises a plurality of fasteners configured to secure the printhead within the printhead bracket in a first orientation and in a second orientation.

15. The printing apparatus of claim 14, wherein the first orientation and the second orientation of the printhead is modified by a user, wherein the user unfastens the plurality of fasteners, removes the printhead from the printhead bracket, reorients the printhead, attaches the reoriented printhead to the printhead bracket and fastens the plurality of fasteners.

16. The printing apparatus of claim 9, wherein the printhead further comprises:
a first connector and a second connector, wherein the first connector is coupled to a first mating connector and the second connector is coupled to a second mating connector, and, wherein the first connector is configured for sending data to the printhead and the second connector is configured to supply power to the printhead.

17. A method for operating a printing apparatus, the method comprising:
determining, by a controller, an orientation of a printhead in the printing apparatus, wherein the printhead comprises a first burn line of heating elements and a second burn line of heating elements disposed on a first surface of the printhead and a second surface of the printhead, respectively; and,
performing, by the controller, a printing operation using one of the first burn line of heating elements or the second burn line of heating elements based on the orientation of the printhead.

18. The method of claim 17, further comprising activating/operating a switch element to toggle between the first burn line of heating elements and the second burn line of heating elements, wherein the switch element executes switching of the first burn line of heating elements and the second burn line of heating elements to perform the printing operation.

19. The method of claim 18, further comprising receiving an orientation signal from one or more sensors in the printhead, wherein the orientation signal is deterministic of the orientation of the printhead.

20. The method of claim 17, further comprising performing the printing operation using the first burn line of heating elements in an instance in which the printhead is in a first orientation, and performing the printing operation using the second burn line of heating elements in an instance in which the printhead is in a second orientation.
